(19) United States
(12) Patent Application Publication
(10) Pub. No.: US 2021/0309134 A1
(43) Pub. Date: Oct. 7, 2021

(54) SEAT AIR CONDITIONER

(71) Applicant: DENSO CORPORATION, Kariya-city (JP)

(72) Inventors: Masafumi KAWASHIMA, Kariya-city (JP); Shuji ITO, Kariya-city (JP); Hironobu MURAKAMI, Kariya-city (JP); Takahisa FUJII, Kariya-city (JP)

(21) Appl. No.: 17/348,105

(22) Filed: Jun. 15, 2021

Related U.S. Application Data
(63) Continuation of application No. PCT/JP2019/044715, filed on Nov. 14, 2019.

(30) Foreign Application Priority Data
Dec. 19, 2018 (JP) 2018-237458

(51) Int. Cl. B60N 2/56; B60N 2/00

(52) U.S. Cl. CPC B60N 2/5628; B60N 2/002; B60N 2/565

(57) ABSTRACT

A seat air conditioner includes an air passage that is disposed in a seat of the vehicle, a blower that blows air into the air passage, an outlet through which the air flowing through the air passage is blown as a blown air toward a rear side of a vehicle interior along an upper surface of the seat, and a guide member that is disposed behind the outlet to be moveable between a first position and a second position. The guide member allows the blown air from the outlet to flow toward the rear side of the vehicle interior together with a surrounding air entangled by the blown air when the guide member is at the first position and guides the blown air from the outlet toward a ceiling side or a floor side of the vehicle interior when the guide member is at the second position. The guide member is retracted into a housing space defined in the seat when the guide member is at the first position. At least a portion of the guide member protrudes upward from the upper surface of the seat when the guide member is at the second position.

### CROSS REFERENCE TO RELATED APPLICATIONS

This application is a continuation application of International Patent Application No. PCT/JP2019/044715 filed on Nov. 14, 2019, which designated the U.S. and claims the benefit of priority from Japanese Patent Application No. 2018-237458 filed on Dec. 19, 2018. The entire disclosure of all of the above application is incorporated herein by reference.

### TECHNICAL FIELD

The present disclosure relates to a seat air conditioner disposed in a seat of a vehicle.

### BACKGROUND ART

Various types of seat air conditioners mounted in a vehicle seat have been known. Such a conditioner is provided in a front seat of a vehicle, and air drawn from the back portion of the seat surface of the front seat is blown out toward the rear space in the vehicle interior through an outlet formed on a side surface of the front seat, for example. When the air is blown out from the outlet on the side surface of the front seat, air around the blown air (hereinafter, referred to as a “blown air”) is caught in the blown air due to the viscosity of the blown air and is blown toward the rear space in the vehicle interior. Therefore, cold air generated by the vehicle air conditioner disposed in the instrument panel of the vehicle and blown out into the front seat space is entangled by the blown air and is blown into the rear seat space. Thus, the device can improve comfort in both the front seat space and the rear seat space in the vehicle interior.

It should be noted that the front seat space refers to a space in front of the back portion of the seat surface of the front seat in the vehicle interior, and the rear seat space refers to a space behind the back portion of the seat surface of the front seat in the vehicle interior.

### SUMMARY

One aspect of the present disclosure is a seat air conditioner that is mounted in a vehicle. The seat air conditioner includes an air passage that is defined in a seat of the vehicle, a blower that blows air into the air passage, an outlet through which the air flowing through the air passage is blown as a blown air toward a rear side of a vehicle interior along an upper surface of the seat, and a guide member that is disposed behind the outlet and is configured to be moveable between a first position and a second position. The guide member is configured to allow the blown air from the outlet to flow toward the rear side of the vehicle interior together with a surrounding air entangled by the blown air when the guide member is at the first position, and guide the blown air from the outlet toward a ceiling side or a floor side of the vehicle interior when the guide member is at the second position. The guide member is retracted into a housing space defined in the seat when the guide member is at the first position. At least a portion of the guide member protrudes upward from the upper surface of the seat when the guide member is at the second position.

### BRIEF DESCRIPTION OF DRAWINGS

The above and other objects, features and advantages of the present disclosure will become more apparent from the following detailed description made with reference to the accompanying drawings.

FIG. 1 is a schematic view of a vehicle equipped with a seat air conditioner according to a first embodiment.

FIG. 2 is a cross-sectional view of a front seat in which the seat air conditioner is disposed.

FIG. 3 is a diagram of the front seat as viewed in the direction III of FIG. 2.

FIG. 4 is a cross-sectional view showing a guide member at a first position in portion IV of FIG. 2.

FIG. 5 is a cross-sectional view showing the guide member at a second position in portion IV of FIG. 2.

FIG. 6 is a perspective view showing an example of the guide member.

FIG. 7 is a perspective view showing an example of a blowout portion and the guide member according to the first embodiment.

FIG. 8 is a perspective view showing a blowout portion according to a comparative example.

FIG. 9 is a diagram showing the guide member at the second position in the seat air conditioner according to a second embodiment.

FIG. 10 is an expanded view of a portion around the guide member and an upper surface of the seat in FIG. 9.

FIG. 11 is a block diagram showing a control system in the seat air conditioner according to a third embodiment.

FIG. 12 is a diagram showing the guide member at the first position in the seat air conditioner according to a fourth embodiment.

FIG. 13 is a diagram showing the guide member at the second position in the seat air conditioner according to the fourth embodiment.

FIG. 14 is a diagram showing the guide member at the second position in the seat air conditioner according to a fifth embodiment.

FIG. 15 is a diagram showing the guide member at the second position in the seat air conditioner according to a sixth embodiment.

### DESCRIPTION OF EMBODIMENTS

To begin with, a relevant technology will be described first only for understanding the following embodiments.

In a typical seat air conditioner, when an occupant on the front seat uses this conditioner, cold air blown from the vehicle air conditioner toward the front seat space is blown toward the rear seat space regardless of whether an occupant sits on the rear seat. Accordingly, when such a seat air conditioner is used, the air in both the front seat space and the rear seat space is cooled even when there is no occupant on the rear seat. As a result, an energy may be unnecessarily consumed to cool the vehicle interior.

One objective of the present disclosure is to provide a seat air conditioner capable of switching between a state where comfort is improved in both the front seat space and the rear seat space and a state where energy consumption for cooling the vehicle interior is reduced.

As described above, one aspect of the present disclosure is a seat air conditioner that is mounted in a vehicle. The seat air conditioner includes an air passage that is defined in a seat of the vehicle, a blower that blows air into the air passage, an outlet through which the air flowing through the air passage is blown as a blown air toward a rear side of a vehicle interior along an upper surface of the seat, and a guide member that is disposed behind the outlet and is configured to be moveable between a first position and a second position. The guide member is configured to allow the blown air from the outlet to flow toward the rear side of the vehicle interior together with a surrounding air entangled by the blown air when the guide member is at the first position, and guide the blown air from the outlet toward a ceiling side or a floor side of the vehicle interior when the guide member is at the second position. The guide member is retracted into a housing space defined in the seat when the guide member is at the first position. At least a portion of the guide member protrudes upward from the upper surface of the seat when the guide member is at the second position.

Accordingly, when the guide member is at the first position, the air blown out from the outlet flows toward the rear side of the vehicle interior along the upper surface of the seat. At this time, air around the blown airflow flowing along the upper surface of the seat (that is, air near the blown air and air in front of the blown air) is also caught in the blown air due to the viscosity of the air and is supplied toward the rear side of the vehicle interior. Hereinafter, the flow of air caught in the blown air is referred to as an “entangled air”. That is, cold air generated by the vehicle air conditioner disposed in an instrument panel of the vehicle and blown out into the front seat space is blown into the rear seat space as an entangled air entangled by the blown air blown from the seat air conditioner. Accordingly, by having the guide member at the first position, the seat air conditioner can increase comfort in both the front seat space and the rear seat space when, for example, occupants exist on both the front seat and the rear seat.

On the contrary, when the guide member is at the second position, the air blown out from the outlet flows along the upper surface of the seat, and then is guided toward the ceiling side of the vehicle interior by the guide member. Then, the air guided by the guide member forms an air curtain as an air wall that separates the front seat space from the rear seat space. Accordingly, the air around the blown air flowing along the upper surface of the seat is blocked from flowing toward the rear side of the vehicle interior. As a result, when an occupant exists only on the front seat, for example, the cold air in the front seat space is inhibited from being blown into the rear seat space, and the temperature difference between the front seat space and the rear seat space generates. Therefore, the seat air conditioner can improve comfort in the front seat space and reduce the energy consumed when cooling the vehicle interior by having the guide member at the second state.

Embodiments of the present disclosure will now be described with reference to the drawings. Parts that are identical or equivalent to each other in the following embodiments are assigned the same reference numerals and will not be described.

### First Embodiment

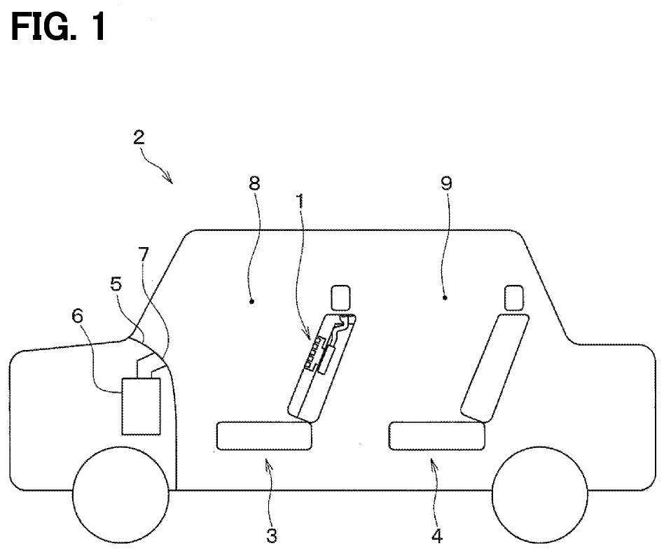

A first embodiment will be described with reference to the drawings. As shown in FIG. 1, the vehicle 2 in which a seat air conditioner 1 of the present embodiment is mounted has two seat rows with front seats 3 and rear seats 4. The seat air conditioner 1 of the present embodiment is disposed in the front seat 3. Alternatively, the seat air conditioner 1 may be disposed in both the driver seat and the passenger seat of the front seats 3 or may be disposed in either one of them. In the following description, the front seat 3 may be referred to as a “seat,” and the rear seat 4 may be referred to as a rear seat.

A vehicular air conditioner 1 for air-conditioning a vehicle interior is disposed inside an instrument panel 5 of the vehicle 2. The vehicle air conditioner 6 draws air outside of the vehicle interior or air inside of the vehicle and blows out conditioning air having an adjusted temperature and humidity into the vehicle interior through an air outlet 7 formed on the instrument panel 5 or the like.

In the following description, the space in front of the seat back of the front seat 3 is referred to as a front seat space 8 and the space behind the seat back of the front seat 3 is referred to as a rear seat space 9 in the vehicle interior.

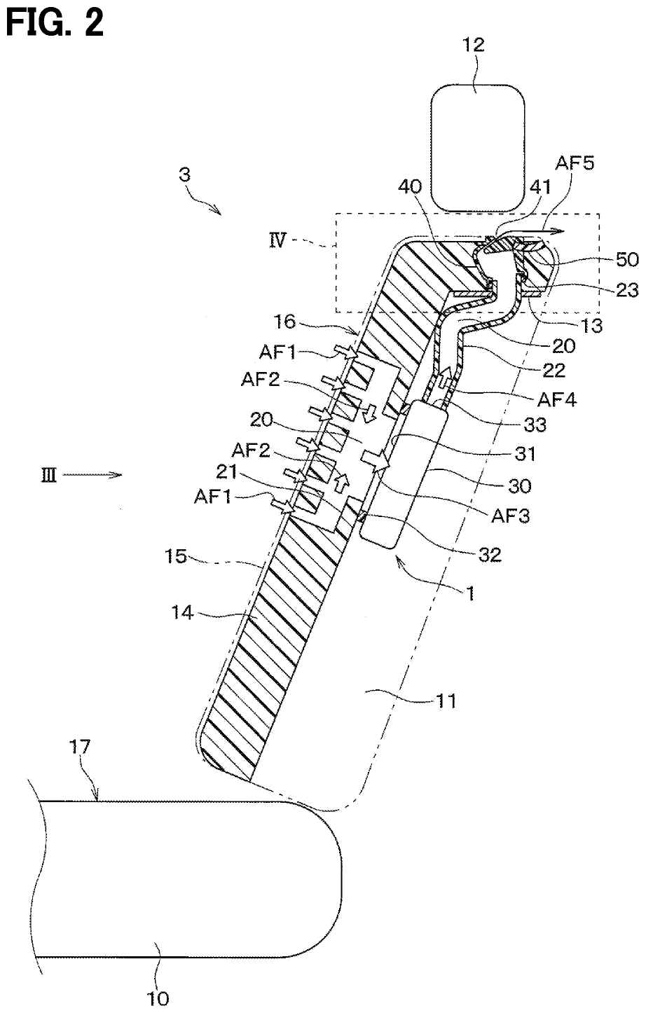

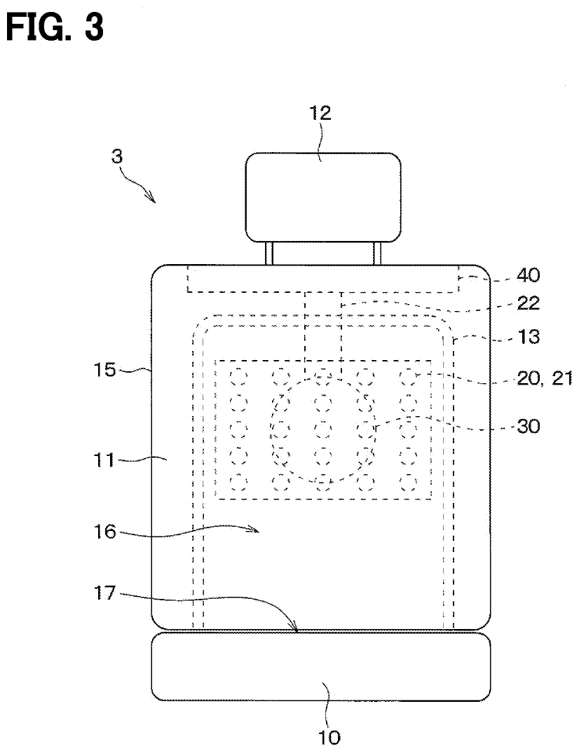

As shown in FIGS. 2 and 3, the seat having the seat air conditioner 1 includes a seat cushion 10 and a seat back 11. A headrest 12 is provided above the seat back 11. The seat back 11 of the seat has a structure in which a pad 14 is disposed on springs (not shown) attached to the frame 13, and the entire surface is covered with a cover 15. The pad 14 is a member that supports the pressure from an occupant leaning against the seat back 11. As the pad 14, a soft material (for example, urethane) that disperses the force from the occupant is used. The cover 15 is in direct contact with the occupant. As the cover 15, for example, a leather, synthetic leather, or cloth (for example, fabric) having holes for allowing air to pass therethrough is used. In the following description, among the seating surfaces of the seat cover 15 that contact the occupant, a portion that contacts the occupant's back is referred to as a back portion 16, and a portion that contacts the occupant's lower body is referred to as a buttock portion 17.

The seat air conditioner 1 includes an air passage 20, a blower 30, a blowout portion 40, a guide member 50, and the like.

The air passage 20 is formed of a ventilation passage 21 formed in the seat and an air distribution duct 22. The ventilation passage 21 is an air passage formed in the pad 14 of the seat. One end of the ventilation passage 21 is open toward a portion of the cover 15 that forms the back portion 16 of the seat. The other end of the ventilation passage 21 is open toward a suction port 31 of the blower 30. Therefore, the ventilation passage 21 is able to guide, toward the blower 30, the air that has passed through the cover 15 of the back portion 16 of the seat.

The blower 30 is a device that is configured to draw air from the cover 15 of the back portion 16 of the seat through the ventilation passage 21 and supplying the air to the blowout portion 40 through the air distribution duct 22. As the blower 30, for example, a centrifugal blower such as a turbo fan, a sirocco fan, or a radial fan may be used. However, the type of the blower 30 is not limited to the above-described types, and various other types such as an axial fan, a mixed flow fan, and a cross flow fan may be used. A suction port packing 32 is disposed between the suction port 31 of the blower 30 and the pad 14. The suction port packing 32 is a member that fills a gap between the blower 30 and the pad 14, and a compressed porous urethane, for example, may be used.

The air distribution duct 22 is a structural member that forms an air passage fluidly connecting between the blower 30 and the blowout portion 40. One end of the air distribution duct 22 is connected to the air outlet 33 of the blower 30. The other end of the air distribution duct 22 is connected to the blowout portion 40. Therefore, the air distribution duct 22 is able to guide the air blown from the air outlet 33 of the blower 30 toward the blowout portion 40. A duct packing 23 is disposed between the air distribution duct 22 and the blowout portion 40. The duct packing 23 is a member that fills a gap between the air distribution duct 22 and the blowout portion 40, and a compressed porous urethane, for example, is used.

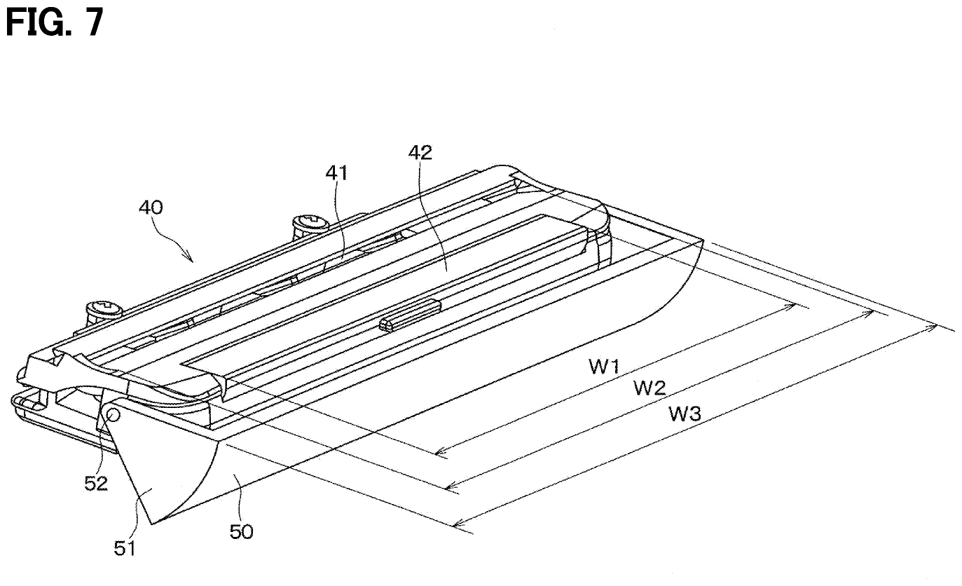

The blowout portion 40 is disposed in an upper portion of the seat back 11. The blowout portion 40 is a member that defines an outlet 41 through which the air supplied from the air distribution duct 22 is blown out. As shown in FIGS. 3 and 7, the blowout portion 40 has a elongated shape extending in the vehicle width direction. Therefore, the blowout portion 40 extends over most of the width of the seat back 11. The outlet 41 formed in the blowout portion 40 is also formed to extend over a wide range in the vehicle width direction. Therefore, the outlet 41 extends over a most area of the seat back 11 in the vehicle width direction.

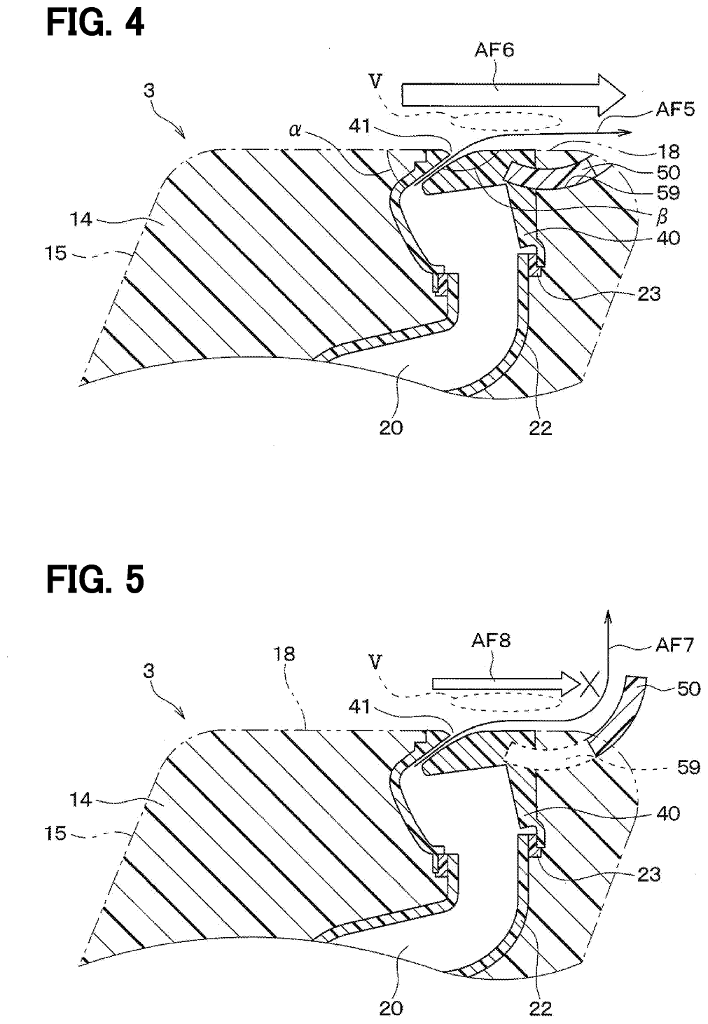

Further, the outlet 41 is formed so as to blow out the air flowing through the air passage 20 toward the rear side of the vehicle interior along the upper surface of the seat (hereinafter, referred to as an “upper surface 18” of the seat). Specifically, as shown in FIG. 4, an acute angle α is formed between a surface of the upper surface 18 of the sheet 18 in front of the outlet 41 and a front wall of the outlet 41. Further, an obtuse angle β is formed between a surface of the upper surface 18 of the sheet behind the outlet 41 and a rear wall of the outlet 41.

It should be noted that, as shown in FIG. 7, an adjusting mechanism 42 for adjusting a blowing direction of air blown from the outlet 41 toward the rear side of the vehicle interior may be disposed in the blowout portion 40. A width W1 of the adjusting mechanism 42 is smaller than a width W2 of the outlet 41.

The guide member 50 is disposed at a position behind the outlet 41. The guide member 50 of the present embodiment has an arcuate cross-section. Further, the guide member 50 is formed to extend in the vehicle width direction. A width W3 of the guide member 50 is longer than the width W2 of the outlet 41. Therefore, as shown in FIG. 7, the width W3 of the guide member 50, the width W2 of the outlet 41, and the width W1 of the adjusting mechanism 42 form a relationship of W3>W2>W1.

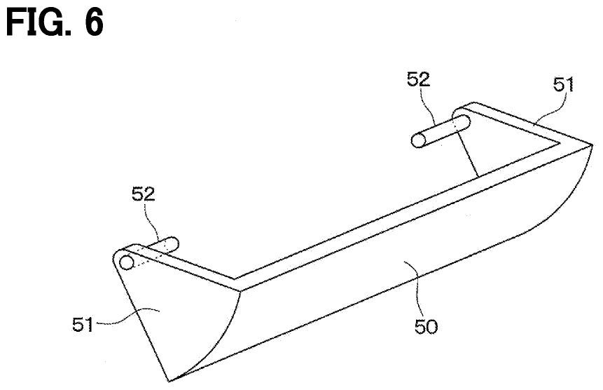

As shown in FIG. 6, the guide member 50 is rotatable about rotational shafts 52 of supports 51 provided at both ends in the width direction thereof. The guide member 50 may be rotated by a manual operation by an occupant, or may be rotated by an electric motor (not shown).

As shown in FIGS. 4 and 5, the guide member 50 is configured to be moveable between a first position and a second position as described below. The first position is a position of the guide member 50 that allows the air blown out from the outlet 41 to be supplied to a rear side of the vehicle interior together with surrounding air. The second position is a position of the guide member 50 that guides the air blown out from the outlet 41 toward a ceiling side or a floor side of the vehicle interior.

FIG. 4 shows an example of the first position of the guide member 50. The guide member 50 at the first position is retracted (or housed) into a housing space 59 formed in the seat. Accordingly, the guide member 50 allows the air blown out from the outlet 41 to be supplied to a rear side of the vehicle interior together with surrounding air.

On the contrary, FIG. 5 shows an example of the second position of the guide member 50. At the second position, at least a part of the guide member 50 is exposed to an outside of the housing space 59. Then, at the second position, the guide member 50 of the present embodiment extends, at a position behind the outlet 41, from the seat upper surface 18 toward the ceiling side in the vehicle interior. As a result, the guide member 50 guides, toward the ceiling side, air blown from the outlet 41 to the rear side in the vehicle interior.

Next, the operation of the vehicle air conditioner 1 of the present embodiment will be described.

When the blower 30 of the seat air conditioner 1 starts, air is drawn into the ventilation passage 21 through a portion of the cover 15 serving as the back portion 16 of the seat, as shown by arrows AF1 in FIG. 2. As shown by arrows AF2 and AF3, air flowing through the ventilation passage 21 is collected at the suction port 31 of the blower 30. Next, as shown by arrow AF4, air blown from the air outlet 33 of the blower 30 to the air distribution duct 22 flows toward the blowout portion 40 through the air passage 20 in the air distribution duct 22. Then, as shown by arrow AF5, the air that has flowed into the blowout portion 40 is blown out into the vehicle interior through the outlet 41.

As shown in FIG. 4, when the guide member 50 is at the first position, the air blown out from the outlet 41 flows toward the rear side of the vehicle interior along the upper surface 18 of the seat as shown by arrow AF5. At this time, air around the blown air flowing along the upper surface 18 of the seat (that is, air near the blown air and air in front of the blown air) is also caught in the blown air due to the viscosity of the air and is supplied toward the rear side of the vehicle interior. Hereinafter, the flow of air caught in the blown air is referred to as an “entangled air”. In FIG. 4, the viscosity of air is schematically indicated by broken line V, and the entangled air is indicated by arrow AF6.

In this way, when the guide member 50 is at the first position, the air around the blown air from the outlet 41 is caught in the blown air and is supplied toward the rear side of the vehicle interior, so that air in the front seat space 8 is blown into the rear seat space 9. Therefore, cold air generated by the vehicle air conditioner 6 disposed in the instrument panel 5 of the vehicle 2 and blown out into the front seat space 8 is blown into the rear seat space 9 as the entangled air. Accordingly, by having the guide member 50 at the first position, the seat air conditioner 1 can increase comfort in both the front seat space 8 and the rear seat space 9 when, for example, occupants exist on both the front seat 3 and the rear seat 4.

On the contrary, as shown in FIG. 5, when the guide member 50 is at the second position, the air blown out from the outlet 41 flows along the upper surface 18 of the seat as shown by arrow AF7, and then is guided toward the ceiling side of the vehicle interior by the guide member 50. Then, the air guided by the guide member 50 forms an air curtain as an air wall that separates the front seat space 8 from the rear seat space 9. Therefore, as shown by arrow AF8, the air around the blown air flowing along the upper surface 18 of the seat is blocked from flowing toward the rear side of the vehicle interior. As a result, when an occupant exists only on the front seat 3, for example, the cold air in the front seat space 8 is inhibited from being blown into the rear seat space 9, and thus the temperature difference between the front seat space 8 and the rear seat space 9 generates. Therefore, the seat air conditioner 1 can improve comfort in the front seat space 8 and reduce the energy consumed by the vehicle air conditioner 6 when cooling the vehicle interior by having the guide member 50 at the second position.

Here, in order to compare with the seat air conditioner 1 according to the first embodiment as described above, a blowout portion 400 included in a seat air conditioner according to a comparative example will be described below. It should be noted that the blowout portion 400 included in the seat air conditioner of his comparative example has been developed by the same applicant as this disclosure, and therefore has not yet been a known technology at the time of filing the present disclosure.

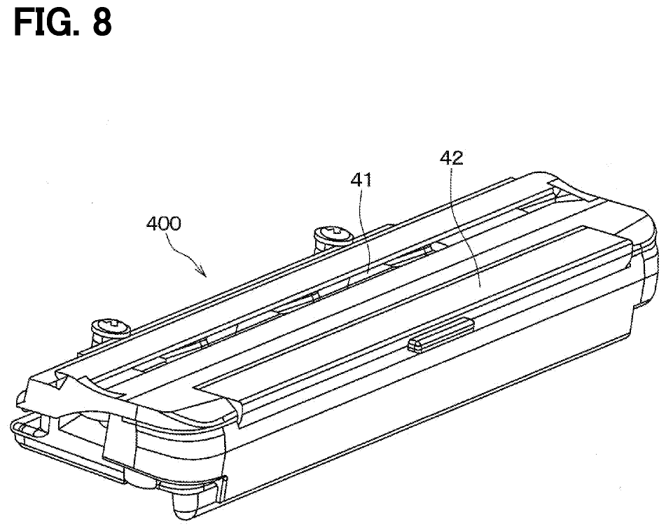

As shown in FIG. 8, the blowout portion 400 of the seat air conditioner of the comparative example does not include the guide member 50. Therefore, in the seat air conditioner of the comparative example, when the blower 30 starts, the air around the outlet 41 is entangled by the air blown out from the outlet 41 and is blown to the rear side of the vehicle interior as with the first embodiment described above. Therefore, since the air in the front seat space 8 is blown into the rear seat space 9, comfort in both the front seat space 8 and the rear seat space 9 can be improved. Further, since the blowout portion 400 of the comparative example includes the adjustment mechanism 42, an occupant on the rear seat 4 can adjust the direction of the air blown out from the outlet 41.

However, in the seat air conditioner of the comparative example, when an occupant on the front seat 3 uses this device, the air in the front seat space 8 is blown into the rear seat space 9 regardless of whether an occupant is on the rear seat 4. Accordingly, when the seat air conditioner of the comparative example is used, the air in both the front seat space 8 and the rear seat space 9 is cooled even when there is no occupant on the rear seat 4. As a result, energy may be unnecessarily consumed to cool the vehicle interior by the vehicle air conditioner 6.

The seat air conditioner 1 of the first embodiment described above has the following advantages as compared to the seat air conditioner according to the comparative example.

That is, both the seat air conditioner 1 of the first embodiment and the seat air conditioner of the comparative example improve comfort of an occupant by drawing a steamed air between the occupant on the seat and the back portion of the seat. That is, both air conditioners serve as a SVS (Seat Ventilation System) that improves comfort of the occupant. Further, both the seat air conditioners serve as a SBC (Seat Back Circulator) that improves comfort in both the front seat space 8 and the rear seat space 9 by blowing air in the front seat space 8 toward the rear seat space 9.

However, in the seat air conditioner of the comparative example, when an occupant on the front seat 3 uses the conditioner as a SVS, air in the front seat space 8 is blown into the rear seat space 9 regardless of whether an occupant is on the rear seat 4. Therefore, an energy to cool the vehicle interior may be unnecessarily consumed by the vehicle air conditioner 6. From the viewpoint of reducing the energy consumption, it is preferable not to cool the rear seat space 9 as much as possible to make a temperature difference between the front seat space 8 and the rear seat space 9 when no occupant is on the rear seat 4.

In view of this, the seat air conditioner 1 of the present embodiment is configured to change the flow direction of the air that is flowing along the upper surface 18 of the seat to an upper direction that is substantially along the vertical direction by having the guide member 50 at the second position when no occupant is on the rear seat 4. The air guided by the guide member 50 serves as an air curtain between the front seat space 8 and the rear seat space 9. At that time, since the entangled air generated due to the viscosity of the air flows along the side surface of the seat, air is prevented from flowing into the rear seat space 9 by the blown air whose airflow direction was changed to the vertical direction by the guide member 50. As a result, a temperature difference generates between the front seat space 8 and the rear seat space 9. Therefore, the seat air conditioner 1 can improve comfort in the front seat space 8 and reduce the energy consumed when cooling the vehicle interior by having the guide member 50 at the second state.

In the first embodiment, the width W3 of the guide member 50 is longer than the width W2 of the outlet 41. In order to prevent the flow of the air toward the rear seat space 9 by the guide member 50, the width W3 of the guide member 50 needs to be longer than the width W2 of the outlet 41. Even if the width W3 of the guide member 50 is short, the same effect can be obtained. However, it is not favorable because a backflow may be generated to some extent.

On the other hand, the usage of the adjusting mechanism 42 disposed in the outflow portion 40 is to adjust the flow direction of the air as desired by the occupant on the rear seat 4. Therefore, an airflow adjustment range by the adjusting mechanism 42 is assumed as a circumferential region around the occupant on the rear seat 4, and thus the adjusting mechanism 42 has no function of changing the flow direction of the air to the substantially vertical direction. Further, the width W1 of the adjusting mechanism 42 is shorter than the width W2 of the outlet 41. This is because the adjusting mechanism 42 aims to widen the scope of ventilation.

On the contrary, according to the first embodiment, the width W3 of the guide member 50 in the vehicle width direction is longer than the width W2 of the outlet 41. Thus, when the guide member 50 is at the second position, a wide air curtain can be formed by utilizing almost all of the air blown out from the outlet 41. Therefore, by enhancing the shielding effect by the air curtain, the seat air conditioner 1 can improve comfort in the front seat space 8 and reduce the energy for cooling the vehicle interior by setting the guide member 50 at the second position.

### Second Embodiment

A second embodiment will be described below. In the second embodiment, the configuration of the guide member 50 is changed from that of the first embodiment, and the remaining configurations are the same as those of the first embodiment, and therefore, only portions different from the first embodiment will be described.

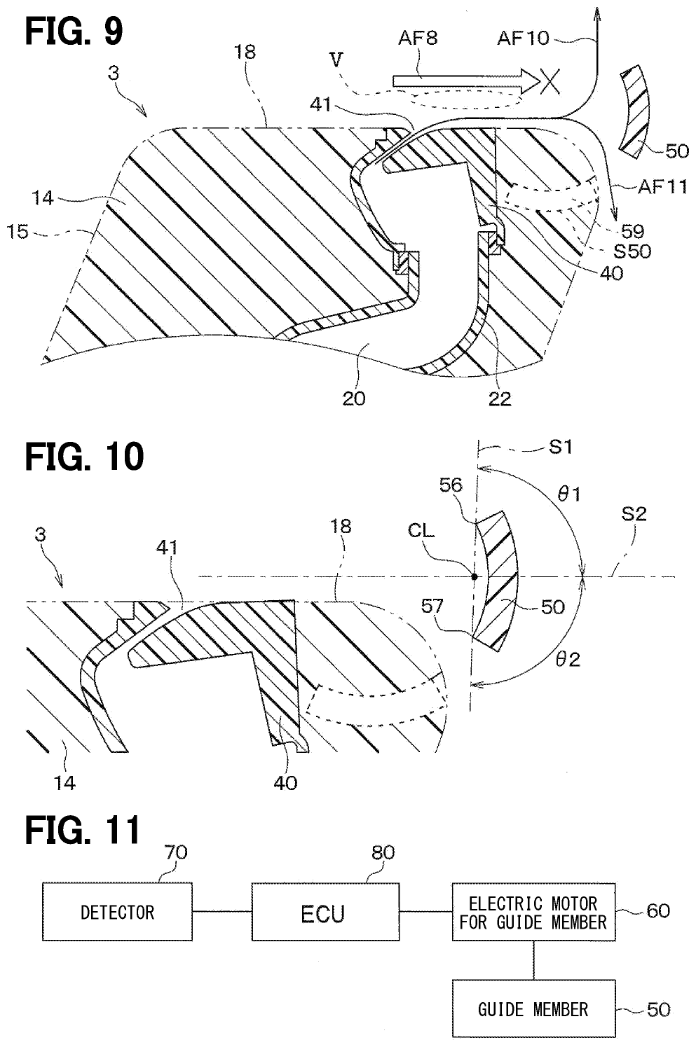

As shown in FIG. 9, in the second embodiment, the movable range of the guide member 50 is different from that in the first embodiment. As shown in FIG. 9, when the guide member 50 of the second embodiment is at the second position, both the upper end and the lower end of the guide member 50 are exposed to an outside of the sheet. In this state, the guide member 50 guides, toward both the ceiling side and the floor side of the vehicle interior, the air that is blown out from the outlet 41 to the rear side of the vehicle interior. Specifically, as shown by arrow AF10, the blown air guided by the guide member 50 toward the ceiling of the vehicle forms an air curtain above the seat.

On the contrary, as shown by arrow AF11, the blown air guided by the guide member 50 toward the floor of the vehicle forms an air curtain below the seat. Here, cold air blown from the vehicle air conditioner 6 into the front seat space 8 has a heavy specific gravity, and therefore goes downward in the vehicle interior. In view of this, in the second embodiment, by forming the air curtain below the seat by the guide member 50, it is possible to prevent the cold air in a lower space of the vehicle interior space from flowing into the rear seat space 9.

A broken line S50 in FIG. 9 indicates the guide member 50 at the first position. The guide member 50 at the first position is retracted into a housing space 59 formed in the seat. The guide member 50 at the first position allows air blown from the outlet 41 to flow toward the rear side of the vehicle interior.

In the second embodiment, the angle of the guide member 50 at the second position is set as follows.

As shown in FIG. 10, a plane connecting the upper end 56 and the lower end 57 of the front surface of the guide member 50 is defined as a first virtual surface S1. A plane that is in parallel with the seat upper surface 18 and includes the center CL between the upper end 56 and the lower end 57 of the front surface of the guide member 50 is defined as a second virtual surface S2. Then, angles formed between the first virtual surface S1 and the second virtual surface S2 are defined as angles θ1 and θ2. Note that the angles θ1 and θ2 are angles formed on a rear side of the first virtual surface S1. At this time, the angle θ1 and θ2 of the guide member 50 at the second position are set to be within the range of 45°<=θ1<=135° and −45°>=θ2>=−135°, respectively.

By setting the angles θ1 and θ2 when the guide member 50 is at the second position in this way, the angle of the mainstream of the blown air forming the air curtain can be set to approximately 45° to 135° or approximately −45° to −135° with respect to the upper surface 18 of the seat. As a result, it is possible to enhance the function of the air curtain as an air wall that separates the front seat space 8 from the rear seat space 9 and to prevent the cold air in the front seat space 8 from moving into the rear seat space 9. Therefore, the seat air conditioner 1 according to the second embodiment can further improve comfort in the front seat space 8 and further reduce the energy consumed by the vehicle air conditioner 6 when cooling the vehicle interior.

### Modification to the Second Embodiment

In the above description of the second embodiment, the guide member 50 has the angles θ1 and θ2 at the second position within the range of 45°<=θ1<=135° and −45°>=θ2>=−135°, respectively. However, the rages of the angles θ1 and θ2 are not necessarily limited to this range. For example, in a modification to the second embodiment, the guide member 50 at the second position is configured to have the angles θ1 and θ2 within the range of 60°<=θ1<=120° and −60°>=θ2>=−120°, respectively. Further, it is more preferable that the guide member 50 at the second position is configured to have the angles θ1 and θ2 that are substantially perpendicular to the seat upper surface 18. By setting the angles in this way, it is possible to cause an angle of a mainstream of the blown air that forms the air curtain to be perpendicular to the seat upper surface 18. As a result, it is possible to enhance the function of the air curtain as an air wall that separates the front seat space 8 from the rear seat space 9 and to prevent the cold air in the front seat space 8 from moving into the rear seat space 9.

### Third Embodiment

A third embodiment will be described below. In the third embodiment, an operating way of the guide member 40 is changed from the first embodiment, and the other parts are similar to that in the first embodiment, so only the difference from the first embodiment will be described.

FIG. 11 is a block diagram showing a control system of the seat air conditioner 1 according to the third embodiment. In the third embodiment, the guide member 50 is configured to be rotated by an electric motor 60 for driving the guide member.

The vehicle 2 with the seat air conditioner 1 according to the third embodiment includes a detector 70 for detecting an occupant on the rear seat 4. As an example of the detector 70, a courtesy switch that detects opening/closing of the rear door, a seat sensor disposed in the rear seat 4, an in-vehicle camera, and the like, may be used. The signal from the detector 70 is transmitted to a controller (ECU: Electronic Control Unit) 80.

The controller 80 includes a microcomputer including a processor for performing control processing and arithmetic processing and a storage unit, such as a ROM and a RAM, for storing a program and data, as well as peripheral circuits thereof. The storage of the controller 80 includes a non-transitory, tangible storage medium. The controller 80 controls the operation of the electric motor 60 connected to an output port depending on whether an occupant is detected by the detector 70. Specifically, the controller 80 controls the guide member 50 to be at the first position when the detector 70 detects the occupant on the rear seat 4. On the contrary, the controller 80 controls the guide member 50 to be at the second position when the detector 70 does not detect an occupant on the rear seat 4.

In the third embodiment described above, the controller 80 switches the guide member 50 to the first position or the second position depending on whether an occupant is on the rear seat 4. The guide member 50 automatically switches between the first position and the second position depending on whether an occupant is on the rear seat 4 without a manual operation by the occupant. Therefore, according to the seat air conditioner 1 of the third embodiment, an occupant need not move the guide member 50, comfort in the front seat space 8 can be improved, and energy consumed for cooling the vehicle interior can be reduced.

### Fourth to Sixth Embodiments

In the fourth to sixth embodiments, the shape of the guide member 40 or the like is changed with respect to the first embodiment, and the other parts are similar to that in the first embodiment, so only the difference from the first embodiment will be described.

### Fourth Embodiment

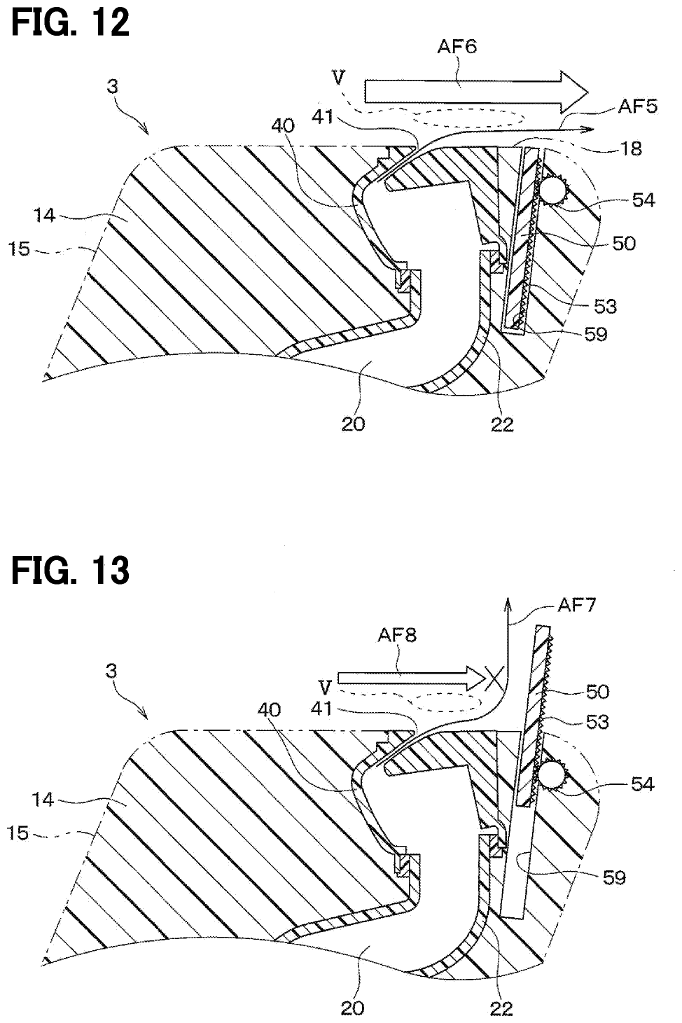

As shown in FIGS. 12 and 13, the guide member 50 in the seat air conditioner 1 according to a fourth embodiment has a linear cross-section. Therefore, the guide member 50 is formed in a flat plate shape. FIG. 12 shows the guide member 50 at the first position, and FIG. 13 shows the guide member 50 at the second position.

The guide member 50 may be driven by, for example, a rack-and-pinion mechanism. In that case, a pinion 54 disposed in the seat meshes with a rack 53 disposed in the guide member 50. When a pinion 54 rotates, the guide member 50 moves between the first position and the second position.

The driving mechanism for the guide member 50 is not limited to this, and the guide member 50 may be moved by a manual operation by an occupant, for example. Further, the guide member 50 may have supports 51 as described in the first embodiment at both ends thereof in the width direction.

### Fifth Embodiment

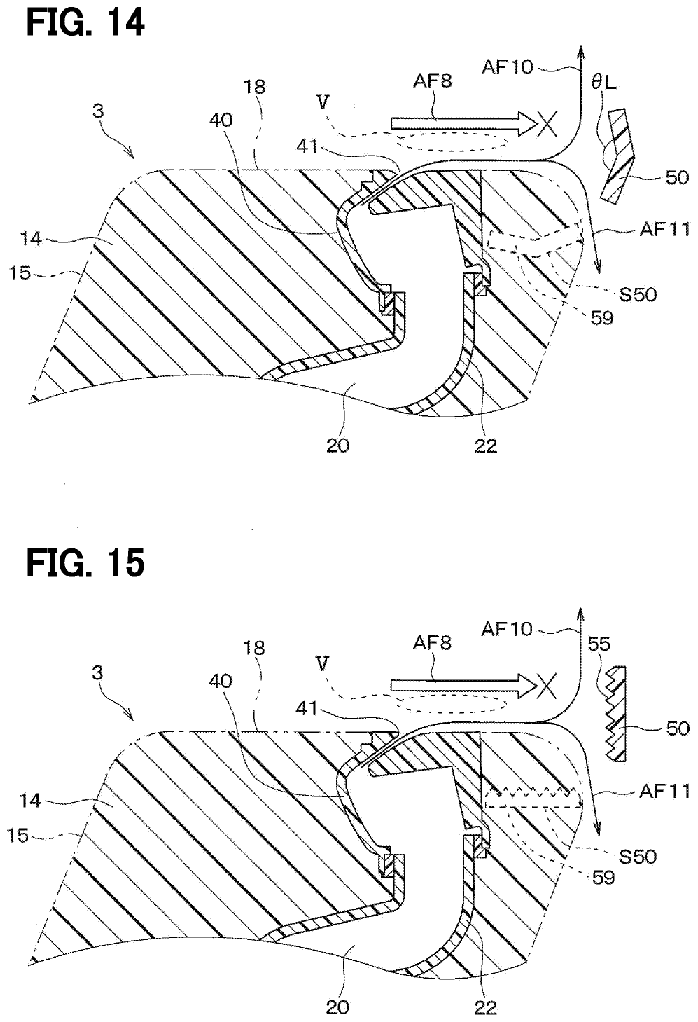

As shown in FIG. 14, the guide member 50 in the seat air conditioner 1 according to the fifth embodiment has a cross-section with a shape defined by two line portions. The angle θL formed between the two line portions is 90°<θL<180° on the front side of the vehicle.

FIG. 14 shows the guide member 50 at the first position by a broken line S50 and the guide member 50 at the second position by a solid line. The driving way of the guide member 50 may be done by a manual operation by an occupant or may be automatically rotated by an electric motor (not shown), as with the other embodiments.

The seat air conditioner 1 according to the fifth embodiment can also exhibit the same operations and advantages as those in the first to fourth embodiments described above.

### Sixth Embodiment

As shown in FIG. 15, the guide member 50 in the seat air conditioner 1 according to the sixth embodiment has a shape with a plurality of uneven portions 55. The plurality of uneven portions 55 are formed on the front surface of the vehicle when the guide member 50 is at the second position.

FIG. 15 shows the guide member 50 at the first position by a broken line S50 and the guide member 50 at the second position by a solid line. The driving way of the guide member 50 may be done by a manual operation by an occupant or may be rotated by an electric motor (not shown), as with the other embodiments.

The seat air conditioner 1 according to the sixth embodiment can also exhibit the same operations and advantages as those in the first to fifth embodiments described above.

### OTHER EMBODIMENTS

The present disclosure is not limited to the embodiments described above, and can be modified as appropriate. The above embodiments are not independent of each other, and can be appropriately combined except when the combination is obviously impossible. Further, in each of the above-mentioned embodiments, it goes without saying that components of the embodiment are not necessarily essential except for a case in which the components are particularly clearly specified as essential components, a case in which the components are clearly considered in principle as essential components, and the like. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Also, the shape, the positional relationship, and the like of the component or the like mentioned in the above embodiments are not limited to those being mentioned unless otherwise specified, limited to the specific shape, positional relationship, and the like in principle, or the like.

The control apparatus and the technique according to the present disclosure may be achieved by a dedicated computer provided by constituting a processor and a memory programmed to execute one or more functions embodied by a computer program. Alternatively, the controller and the technique according to the present disclosure may be achieved by a dedicated computer provided by constituting a processor with one or more dedicated hardware logic circuits. Alternatively, the controller and the method described in the present disclosure may be implemented by one or more special purpose computer, which is configured as a combination of a processor and a memory, which are programmed to perform one or more functions, and a processor which is configured with one or more hardware logic circuits. The computer readable program may be stored, as instructions to be executed by a computer, in the memory which is a tangible non-transitory computer-readable medium. The memory may be provided by a semiconductor memory device or a programmable circuit.

(1) In each of the above embodiments, the seat air conditioner 1 has been described as being mounted in the vehicle 2 having two rows of seats, but the present disclosure is not necessarily limited to this. The seat air conditioner 1 may be mounted in a vehicle 2 having three or more rows of seats. In that case, the seat air conditioner 1 may be disposed in the front row seat 3, or may be disposed in the second front row seat or one of subsequent row seats.

(2) In each of the above embodiments, the guide member 50 in the seat air conditioner 1 has an arc shape, a straight shape (that is, a flat plate), a shape defined by a combination of two lines, or a shape formed of a plurality of uneven portions 55 on the surface. However, the present disclosure is not necessarily limited to this. Various shapes and materials can be used for the guide member 50 and the support 51.

(3) In each of the above embodiments, the air passage 20 in the seat air conditioner 1 has been described as including the ventilation passage 21 and the air distribution duct 22 provided in the seat, but the present disclosure is not necessarily limited to this. The air passage 20 in the seat air conditioner 1 may be any configuration as long as it can guide the air drawn from the cover 15 of the seat or the like toward the blowout portion 40.

(4) In each of the above embodiments, the seat air conditioner 1 has been described as drawing air from the back portion 16 of the seat surface of the seat, but the present disclosure is not necessarily limited to this. The position where the seat air conditioner 1 draws air may be any position on the seat.

(5) In each of the above embodiments, the guide member 50 is retracted into the housing space 59 provided in the seat in the first state, but the present disclosure is not necessarily limited to this. For example, the guide member 50 at the first position may be configured to move downward from the seat upper surface 18 along the cover 15 of the back surface of the seat.

(Overview)

According to the first aspect described in part or all of the above embodiments, the seat air conditioner mounted in the vehicle includes an air passage, a blower, an outlet and a guide member. The air passage is formed in the seat of the vehicle. The blower blows air into the air passage. The air flowing through the air passage is blown out through the outlet toward the rear side of the vehicle interior along the upper surface of the seat. The guide member is disposed at a position behind the outlet. The guide member is configured to move between a first position and a second position where the air blown out from the outlet is allowed to flow toward the rear side of the vehicle interior together with surrounding air when the guide member is at the first position and the air blown out from the outlet is guided by the guide member toward the ceiling side or the floor side of the vehicle interior when the guide member is at the second position.

According to a second aspect, when the guide member is at the first position, the air around the air blown from the outlet is caught in the blown air due to the viscosity of the air and is supplied toward the rear side of the vehicle interior. On the contrary, when the guide member is at the second position, the air around the blown air is blocked from flowing toward the rear side of the vehicle interior by the air blown out from the outlet and guided by the guide member toward the ceiling side or the floor side of the vehicle interior.

Accordingly, when the guide member is at the first position, the air blown out from the outlet flows toward the rear side of the vehicle interior along the upper surface of the seat. At this time, air around the blown air flowing along the upper surface of the seat (that is, air near the blown air and air in front of the blown air) is also caught in the blown air due to the viscosity of the air and is supplied toward the rear side of the vehicle interior. Therefore, cold air generated by the vehicle air conditioner and blown out into the front seat space is blown into the rear seat space as an entangled air entangled by the blown air blown from the seat air conditioner. Accordingly, by having the guide member at the first position, the seat air conditioner can increase comfort in both the front seat space and the rear seat space when, for example, occupants exist on both the front seat and the rear seat.

On the contrary, when the guide member is at the second position, the air blown out from the outlet flows along the upper surface of the seat, and then is guided toward the ceiling side of the vehicle interior by the guide member. Then, the air guided by the guide member forms an air curtain as an air wall that separates the front seat space from the rear seat space. Accordingly, the air around the blown air flowing along the upper surface of the seat is blocked from flowing toward the rear side of the vehicle interior. As a result, when an occupant exists only on the front seat, for example, the cold air in the front seat space is inhibited from being blown into the rear seat space, and a temperature difference between the front seat space and the rear seat space generates. Therefore, the seat air conditioner can improve comfort in the front seat space and reduce the energy consumed when cooling the vehicle interior by having the guide member at the second state.

According to a third aspect, the air passage is configured so that the air drawn through the back portion of the seat surface of the seat flows toward the outlet.

Accordingly, a steamed air between the occupant on the seat and the back portion of the seat is drawn into the air passage of the seat air conditioner. As a result, the seat air conditioner can improve comfort of the occupant on the seat. Furthermore, the seat air conditioner is configured to improve comfort in the rear seat space using the air blown from the outlet when an occupant is on the rear seat. The seat air conditioner is also configured to create an air curtain above or below the seat when no occupant is on the rear seat.

According to a fourth aspect, the width of the guide member is longer than the width of the outlet.

Accordingly, when the guide member is at the second position, a wide air curtain can be formed by utilizing almost all of the air blown out from the outlet. Therefore, by enhancing the shielding effect by the air curtain, the seat air conditioner can improve comfort in the front seat space and reduce the energy for cooling the vehicle interior by setting the guide member at the second position.

According to a fifth aspect, when the guide member is at the second position, angles formed between a first virtual surface connecting the upper end and the lower end of the front surface of the guide member and a second virtual surface that includes the center between the upper end and the lower end thereof and is in parallel with the seat upper surface are defined as angles θ1 and θ2. Then, the angles θ1 and θ2 of the guide member 50 at the second position are set to be within the range of 45°<=θ1<=135° and −45°>=θ2>=−135°, respectively.

Accordingly, when the guide member is at the second position, the angle of the mainstream of the blown air that forms the air curtain can be set to be within approximately 45° to 135° or approximately −45° to −135° relative to the upper seat surface. As a result, it is possible to enhance the function of the air curtain as an air wall that separates the front seat space from the rear seat space and to prevent the cold air in the front seat space from moving into the rear seat space. Therefore, the seat air conditioner can further improve comfort in the front seat space and further reduce the energy for cooling the vehicle interior.

According to a sixth aspect, the seat air conditioner further includes a detector that detects an occupant on the rear seat that is located behind the seat in which the seat air conditioner is disposed, and a controller that is configured to control the guide member according to a detection signal from the detector. The controller is configured to control the guide member to move to the first position when the detector detects the occupant on the rear seat. On the contrary, the controller is configured to control the guide member to move to the second position when the detector does not detect an occupant on the rear seat.

Accordingly, the controller automatically switches the guide member to the first position or the second position depending on whether an occupant is on the rear seat. Therefore, according to the seat air conditioner, an occupant need not move the guide member manually, comfort in the front seat space can be improved, and energy consumed for cooling the vehicle interior can be reduced.

1. A seat air conditioner that is mounted in a vehicle, the seat air conditioner comprising:
an air passage that is defined in a seat of the vehicle;
a blower that blows air into the air passage;
an outlet through which the air flowing through the air passage is blown as a blown air toward a rear side of a vehicle interior along an upper surface of the seat; and
a guide member that is disposed behind the outlet and is configured to be moveable between a first position and a second position, wherein
the guide member is configured to:
allow the blown air from the outlet to flow toward the rear side of the vehicle interior together with a surrounding air entangled by the blown air when the guide member is at the first position; and
guide the blown air from the outlet toward a ceiling side or a floor side of the vehicle interior when the guide member is at the second position,
the guide member is retracted into a housing space defined in the seat when the guide member is at the first position, and
at least a portion of the guide member protrudes upward from the upper surface of the seat when the guide member is at the second position.

2. The seat air conditioner according to claim 1, wherein
the surrounding air around the blown air is caught in the blown air due to viscosity of air and is supplied toward the rear side of the vehicle interior when the guide member is at the first position, and
the surrounding air around the blown air is blocked from flowing toward the rear side of the vehicle interior by the blown air that is guided by the guide member toward the ceiling side or the floor side of the vehicle interior when the guide member is at the second position.

3. The seat air conditioner according to claim 1, wherein
the air passage is configured to guide the air drawn through a back portion of a seat surface of the seat toward the outlet.

4. The seat air conditioner according to claim 1, wherein
the guide member has a width that is longer than a width of the outlet.

5. The seat air conditioner according to claim 1, wherein
when the guide member is at the second position, an angle θ1 and an angle θ2 are formed between a first virtual surface connecting an upper end and a lower end of a front surface of the guide member and a second virtual surface that includes a center between the upper end and the lower end and is in parallel with the upper surface of the seat, and
the angle θ1 and the angle θ2 of the guide member are set to be within a range of 45°<=θ1<=135° and a range of −45°>=θ2>=−135°, respectively.

6. The seat air conditioner according to claim 1, further comprising:
a detector that detects an occupant on a rear seat behind the seat in which the seat air conditioner is disposed; and
a controller that is configured to:
control the guide member to move to the first position when the detector detects an occupant on the rear seat; and
control the guide member to move to the second position when the detector detects no occupant on the rear seat.
